(19) United States
(12) Patent Application Publication
(10) Pub. No.: US 2025/0335508 A1
(43) Pub. Date: Oct. 30, 2025

(54) DETECTING AND HANDLING INCOMPLETE QUERIES IN CONVERSATIONAL SYSTEMS USING LARGE LANGUAGE MODELS AND CLASSICAL PLANNERS

(71) Applicant: INTUIT INC., Mountain View, CA (US)

(72) Inventors: Sudhir AGARWAL, Palo Alto, CA (US); Anu SREEPATHY, Sunnyvale, CA (US)

(21) Appl. No.: 18/647,308

(22) Filed: Apr. 26, 2024

(51) Int. Cl. G06F 16/9032

(52) U.S. Cl. CPC G06F 16/90332

(57) ABSTRACT

Aspects of the present disclosure relate to techniques for automatically detecting and responding to incomplete user queries. Embodiments include receiving a query from a user; generating a planning language representation of the query using a language processing machine learning model; determining that the query did not provide a particular item of information, wherein the particular item of information is used for executing an execution plan; generating the execution plan based on the planning language representation using an artificial intelligence (AI) planner, wherein the execution plan includes requesting that the user provide the one or more particular items of information; executing the execution plan, comprising requesting the particular item of information from the user; and generating a response to the user query based on the executing of the execution plan.

### INTRODUCTION

Aspects of the present disclosure relate to techniques for automatically generating responses to user queries. In particular, techniques described herein involve using an artificial intelligence planner to generate a plan for responding to the user query that includes requesting additional information from the user, and then generating a response based on the plan.

### BACKGROUND

A growing number of people, businesses, and organizations around the world utilize language models to assist with a wide variety of tasks. For example, an individual may request that a language model generate a certain type of content, and the language model may generate the content based on the request.

Language models are generally trained to generate natural language content based on inputs such as user queries. However, due to limitations of language models and/or users of the models failing to provide the models with sufficient information for responding to a query, the responses generated by language models may contain hallucinations (e.g., incorrect or fabricated information). Some existing techniques for preventing hallucinations in automatically generated responses involve using artificial intelligence planners to create a structured plan for generating a response to a query. For example, a plan that is generated based on a user query may involve requesting information such as by submitting calls to various application programming interface (API) functions to gather information, and then using a language model to generate a response based on the gathered information. However, in many instances a query provided by a user may contain insufficient information for generating a plan. In such instances, plan generation may fail, resulting in failure to generate a response to the query. As a result, users may be forced to submit new queries and generate new plans via the planner, resulting in a waste of computational resources that would otherwise be conserved if plan generation were successful.

Thus, there is a need in the art for improved planner-based automated response generation.

### BRIEF SUMMARY

Certain embodiments provide a method of generating a response to a user query. The method generally includes: receiving a query from a user; generating a planning language representation of the query using a language processing machine learning model; determining that the query did not provide one or more particular items of information, wherein the particular items of information are used for executing an execution plan; generating the execution plan based on the planning language representation using an artificial intelligence (AI) planner, wherein the execution plan includes requesting that the user provide the one or more particular items of information; executing the execution plan, comprising requesting the one or more particular items of information from the user; and generating a response to the user query based on the executing of the execution plan.

Other embodiments provide a method of generating a response to a user query. The method generally includes: receiving a query from a user; generating a planning language representation of the query using a language processing machine learning model; generating an execution plan based on the planning language representation using an AI planner, wherein the execution plan includes requesting that the user provide one or more particular items of information, wherein the one or more particular items of information are used for executing the execution plan; and generating a response to the user query based on receiving the one or more particular items of information and executing the execution plan.

Other embodiments provide that the plan may be altered based on the items of information provided by the user. For example: it may be determined not to execute one or more steps of the plan based on the information; additional steps may be added to the plan based on the information; and/or an order for executing steps of the plan may be determined based on the additional information.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automatically generating responses to user queries.

FIG. 2 depicts an example of computing components related to automatically generating responses to user queries.

FIG. 3 depicts example operations related to automatically generating responses to user queries.

FIG. 4 depicts additional example operations related to automatically generating responses to user queries.

FIG. 5 depicts an example of a processing system for automatically generating responses to user queries.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically generating responses to user queries using a planner-based language model system.

In various applications, language model systems may be used to generate responses to user queries. By using artificial intelligence (AI) planners that can plan across available application programming interfaces (APIs), language model systems may avoid generating hallucinatory responses that would otherwise be generated by a language processing machine learning model such as a large language model (LLM), such as due to the structure that such planners provide to the automation. However, existing planner-based automated response generation systems rely on complete sets of information being provided as inputs, and fail when certain information is missing. For example, if a user submits a query that lacks information that the planner requires in order to generate a plan, the planner will fail in existing techniques, and the automated response generation system will be unable to generate a response to the query. Embodiments described herein overcome this challenge by configuring an automated response generation system such that when additional information is needed in connection with generating a plan, rather than failing, an AI planner generates a plan that includes presenting a user with a prompt for the additional information. Thus, techniques described herein avoid failure and enable a response to be automatically generated by including the acquisition of additional information as part of a plan that is generated by an AI planner and executed in order to generate the response. By recognizing the need for and subsequently acquiring such information as part of an automatically generated and executed plan, embodiments of the present disclosure enable generation of a response to a user query even when incomplete information is provided in the user query, whereas existing automated response generation systems would otherwise be unable to generate a response or would generate a response that contains hallucinations. For example, techniques described herein (e.g., involving a combination of an AI planner, requests for missing information, and one or more LLMs) solve the technical problem of automatically identifying incomplete information in a user query so that a response can be automatically generated without hallucinations in such cases, when automatically generating such a response was not possible with prior automated response generation techniques.

In some embodiments, a query is received from a user. Generally, user queries are natural language requests for a language model, such as an LLM, to perform a task. The user query may comprise, for example, a question or a request to generate a certain type of content.

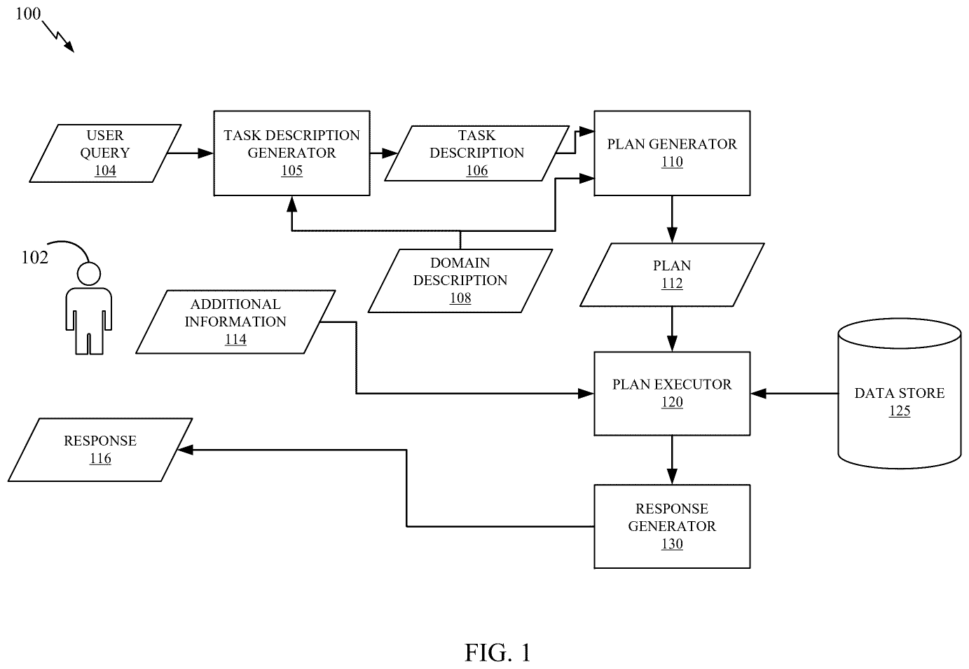

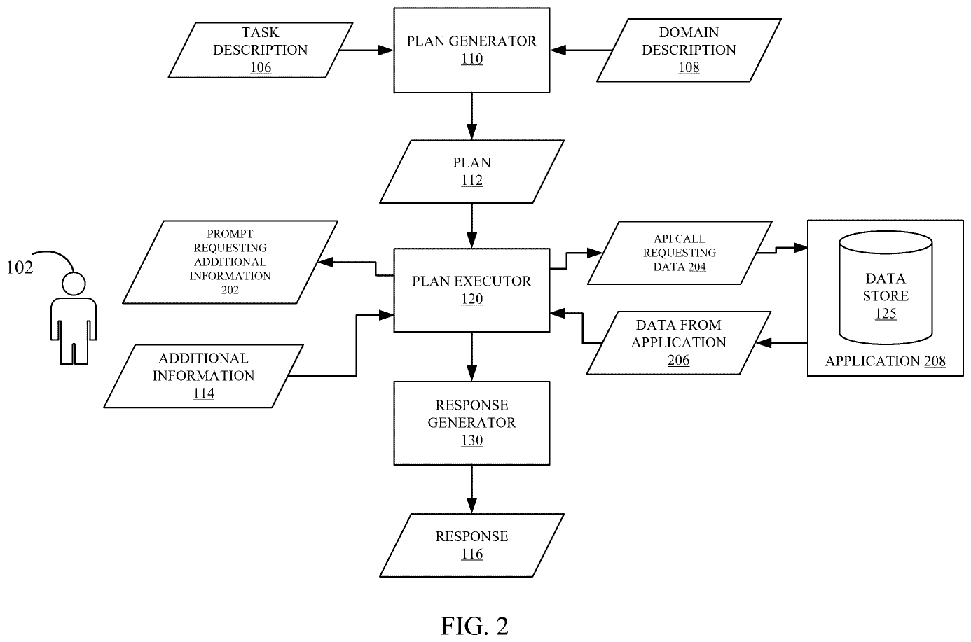

As described in more detail below with respect to FIGS. 1 and 2, certain embodiments provide that a planning language representation of the query may be generated. Planning languages are generally languages used for expressing planning tasks. Planning languages may divide the description of a planning task into a domain description and a task description. In the domain description, invariant rules of a world model, like object types, predicates, and possible actions that may be performed may be described. In some embodiments, one of the actions described by the domain description may be submitting a call to an application programming interface (API) function that asks the user to provide information that may be used for generating a response (or otherwise requesting information from the user), as discussed in further detail below. The task description is based on the domain description and describes a task, such as by indicating an initial state and a goal state for the language model system (e.g., by specifying the objects and predicates that are part of the task). In certain embodiments, the planning language may be a standardized planning language such as Planning Domain Definition Language (PDDL).

Some embodiments provide that a language model (e.g., an LLM) is trained to generate planning language representations of user queries that preserve semantic features of the queries. Such generation may be accomplished based on performing one or more natural language processing tasks, such as semantic analysis, entity extraction, concepts extraction, dependency parsing, topic analysis, and/or the like. For example, the trained language model may map extracted entities to object types described in the domain description.

According to certain embodiments, a planning language description of the user query and a planning language description of a domain may be used to generate an execution plan. The execution plan may include a series of steps that, when executed, result in the generation of a response to the query. For example, executing the plan may comprise submitting calls to API functions specified by a planning language description in an order indicated by an execution plan.

Certain embodiments provide that actions may be assigned a cost, and the planner may choose an optimal plan of multiple possible plans based on a cost determined for the plan. For example, cost determinations may be made based on the amount of computational resources required to execute particular actions, and the plan that requires the fewest resources to successfully respond to a user query may have the lowest cost.

In certain embodiments, the plan may include requesting additional information from the user in order to generate a response to a query. Such a request may be made based on determining that the query did not include a particular item of information that is helpful and/or necessary for generating the response. For example, an entity (e.g., a word or phrase) in a query may be mapped to an object defined in the domain description. Generating a response based on this type of object may require performing a particular type of action, and this action may require additional information not included in the query (e.g., if an action involves extracting data, additional information required for this action may include a time range). Based on determining that this additional information is missing from the query, a step of requesting the additional information from the user may be included in the plan. Certain embodiments provide that requesting the additional information from a user comprises submitting a call to an API function that presents the user with a prompt requesting that the user provide the information. For example, techniques described herein may involve configuring an API function that, when invoked, causes a prompt for particular information (e.g., specified as an input parameter when the function is invoked) to be requested (e.g., via a user interface).

In some embodiments, a new plan may be generated based on the additional information provided by the user (e.g., in response to the prompt). Generation of a new plan may occur, for instance, based on an indication that a user query was mapped incorrectly. For example, generating a response may involve a particular action that requires additional information. Based on receiving a prompt requesting the additional information, the user may provide information that indicates that performance of the action (or another downstream action in the plan) is not relevant to generating a response (e.g., in response to being asked for a time range over which to extract data corresponding to a user's account, the user may indicate that the user has never had an account). The process of generating a new plan may include generating a new planning language representation of the user query.

Some embodiments provide that a plan may be altered based on the additional information provided by the user. For example, a plan may include multiple logical paths that may be followed based on the additional information (e.g., a generated plan may account for two possible actions based on a user query, and one of the actions may be indicated as the correct action based on the additional information). As another example, one or more steps of the plan may be skipped based on the additional information (e.g., the additional information may indicate that a step is not required). Furthermore, additional steps may be executed or an order for executing steps may be determined based on the additional information provided by the user, allowing for dynamic updates to the plan.

Certain embodiments provide that, in response to the additional information, further requests for information may be made. As an example, multiple requests for information from the user may be made until the responses provided by the user provide all information necessary for generating a response. For instance, a user may be prompted to enter a date range, and the user may provide only the starting date. Based on this information, the user may be prompted to enter the end date.

In some embodiments, it may be determined that the automated response generation system is unable to generate a response to a user query. For example, the planner may determine that the query is not answerable or performable using available APIs (e.g., information required for responding to the query is not available because no available API can obtain the information, an API function may return a response indicating that requested information is unavailable, and/or the like). In such instances, the user may be notified that response generation has failed. This presents an advantage over other automated response generation systems, which may generate hallucinatory responses when unable to access information required for generating a response.

According to some embodiments, a response to the user query is generated based on receiving the additional information. For example, once the information that is helpful and/or necessary for generating a response is received, the response may be generated, such as by executing the remainder of the plan and/or executing a new or modified plan (e.g., generated based on the additional information). The response may be generated by a natural language processing machine learning model, such as an LLM, the use of which may be specified in one or more steps of the plan. For example, an LLM may be provided with information that was extracted based on executing the plan, and the LLM may use this information to generate a response to the user query. The response may include performing one or more tasks. For example, a user query may instruct the automated response generation system to send an electronic message to contacts that were recently created by the user; based on this query, the response generated by the automated response generation system may include sending the requested messages.

Embodiments of the present disclosure provide numerous technical and practical effects and benefits. For instance, generating and updating an execution plan that includes prompting users to provide additional information allows for a dynamically adaptable language model system. While other automated response generation systems (such as systems that do not use planners and systems whose plans do not include requesting additional information as needed) may hallucinate or fail to generate responses in situations where queries do not contain sufficient information, teachings of the present disclosure provide for execution plans that acquire additional information and automatically adapt to the new information. Such automatic adaptation allows for a faster, more reliable automated response generation system. For example, techniques described herein avoid generating responses that contain hallucinations and avoid delays and computing resource utilization that would otherwise be associated with receiving a new query and starting the automated response generation process over again when information is unavailable. Additionally, because plan failures are eliminated, the responses and/or plan updates may be generated at speeds far greater than humans are capable of achieving, such as near-instantaneously in response to receiving a query or additional information. Techniques described herein are also able to determine costs associated with plans for automatically responding to user queries, such as based on computational resource costs of tasks included in the plans, thereby enabling an optimal plan to be selected from multiple alternative plans based on such costs and/or enabling a determination to be made of whether to execute a plan based on such a cost.

Furthermore, because hallucinations and plan generation failures are reduced, teachings of the present disclosure also represent an improvement to the efficiency of computing systems. For example, processing resources will not be wasted on generating hallucinatory responses or generating failed execution plans. Additionally, by dynamically re-generating and/or modifying an execution plan as new information becomes available, techniques described herein further improve the functioning of computing systems by avoiding execution of irrelevant or suboptimal logic and the associated cost in computing resources of such execution.

### Example of Computing Components Related to Automatically Generating Responses to User Queries

FIG. 1 depicts an example of computing components related to automatically generating responses to user queries.

A user 102 may interact with a language model system 100 through a user interface. Language model system 100 may be an example of an automated response generation system that involves the use of an AI planner and one or more language processing machine learning models. The user interface may allow the user 102 to submit a user query 104 to the language model system 100. The user query 104 may comprise a natural language question or a natural language request for a language model system 100 to perform a task.

The user query 104 may be provided to a task description generator 105. The task description generator 105 may comprise a language processing machine learning model such as a large language model (LLM). Task description generator 105 may be trained and/or otherwise configured to generate a task description 106 based on the user query 104 and domain description 108. Domain description 108 may comprise a planning language description of object types, predicates, and possible actions that may be performed as part of a plan 112. The domain description may be written in a planning language, such as PDDL.

The task description 106 may comprise a planning language representation of user query 104. The task description 106 may preserve the semantic features of the user query 104 and represent the query 104 as a series of objects and predicates defined in the domain description 108 that may describe an initial state and a goal state. Thus, the task description may describe the query in terms of an initial state and a goal state (e.g., the system must progress from the initial state to the goal state to respond to the query). The task description generator 105 may generate the task description 106 by performing one or more natural language processing tasks, such as semantic analysis, entity extraction, concepts extraction, dependency parsing, topic analysis, and/or the like. In some embodiments, the task description 106 is generated in a standardized planning language such as Planning Domain Definition Language (PDDL).

The task description 106 may be provided to a plan generator 110. The plan generator 110 may comprise an artificial intelligence (AI) planner (e.g., a component running on one or more processors and configured to generate a plan based on a planning language). The domain description 108 may also be provided to plan generator 110. The plan generator 110 may generate a plan 112 based on the task description 106. For example, the task description 106 may indicate a target result or end state to be achieved by executing this plan. The plan generator 110 may be configured to construct a plan comprising actions defined by the domain description 108 in order to achieve the target result or reach the end state. Actions may require additional information 114 that was not provided in the user query 104. As discussed in further detail below with respect to FIG. 2, plan generator 110 may determine that the user query 104 did not provide this information 114, and may generate a plan 112 that includes requesting the information 114 from the user 102, such as via the user interface.

The plan 112 may be provided to a plan executor 120. The plan executor may comprise one or more processors configured to perform tasks such as the actions defined in the domain description 108. As an example, the plan executor 120 may perform one or more application programming interface (API) function calls in order to extract information from data sources such as data store 125. Data store 125 may be a data storage medium that stores data relevant to the user 102 and/or the response 116. Plan executor 120 may be configured to perform other tasks as well, such as requesting additional information 114 from user 102, sending messages, or other tasks performed by planner-based language model systems as known in the art. In some embodiments, the result of executing plan 112 is the generation of a structural representation of a response to user query 104 and/or the information necessary for generating such a response (e.g., so that the response can be generated based on the information through the use of a natural language processing machine learning model). In certain embodiments, the result of executing plan 112 is the response 116 that is provided to the user.

In some embodiments, information gathered by plan executor (e.g., information extracted from data store 125) may be provided to response generator 130. Response generator 130 may comprise a language processing machine learning model (e.g., an LLM) that is trained to generate natural language responses 116 to user queries 104. In some embodiments, response generator 130 represents logic that is indicated in plan 112, and that is executed and/or invoked by plan executor 120 as part of executing plan 112. When provided with structured information gathered by plan executor 120, the response generator 130 may generate a response 116 that does not contain hallucinations. For example, the structured information may be a structural representation of a response to user query 104 and/or the information necessary for generating such a response. The response 116 may be provided to the user 102. The response 116 may also comprise content that is provided to other users, such as electronic messages sent to the other users.

FIG. 2 depicts an example of computing components related to automatically generating responses to user queries.

As discussed above with respect to FIG. 1, plan generator 110 may generate a plan 112. The plan 112 may include actions defined in the domain description 108. These actions may require particular items of additional information 114. For example, an action involving sending an electronic message may require the recipient's contact information; an action involving extracting data may require a time range over which the data should be extracted. Plan generator 110 may evaluate the task description 106 to determine whether the particular item of information has been provided by the user 102. For example, if no entities within the user query were mapped to the object type “start date,” this may indicate that no start date was provided. If a date range is required for information extraction and information extraction is required for generating the response 116, the plan 112 may include requesting that the user 102 provide a start date.

When a plan 112 that includes requesting additional information 114 from a user 102 is provided to plan executor 120, plan executor 120 may present user 102 with a prompt requesting additional information 202. This prompt 202 may be generated by calling an API function that is configured to present prompts to the user 102. The API function may take a description of the required additional information 114 as input and generate a prompt 202 based on the description. For example, the description may indicate a type of information that is needed, and a prompt 202 may be selected from a set of prompts based on the indication (or a prompt template may be populated based on the indication). When presented with the prompt 202, such as via a user interface, the user 102 may provide the additional information 114.

In some cases, execution of the plan continues after receiving the additional information 114. The additional information 114 may impact execution of the plan 112. In some embodiments, one or more steps of the plan 112 may be skipped based on the additional information 114. For example, the additional information 114 may indicate that a step is not required or helpful for generating a response 116. In other embodiments, the plan 112 may contain multiple logical paths, and one path of the multiple paths may be chosen. For example, the user query may contain an ambiguity, and the user 102 may provide additional information 114 that resolves the ambiguity, resulting in the selection of one of the paths. Some embodiments provide that an order for executing steps of the plan 112 may be determined based on the additional information 114. For example, a plan 112 may include various steps, and a subset of these steps may be arranged in an order and executed based on the additional information.

Additional information 114 may indicate that additional steps should be added to the plan 112 (e.g., additional information 114 may include an indication that generating a response 116 requires additional tasks). For example, a user 102 may indicate that data should be extracted over two time periods instead of just one time period. Based on this indication, a step that requires requesting an additional start and end date may be added to the plan 112.

Additional information 114 may indicate that a new plan 112 should be generated. For example, additional information 114 provided by user 102 may indicate that a query was incorrectly mapped (e.g., the response 116 the user 102 intended to generate using the query is different than a response 116 that would be generated based on the task description 106). Generating a new plan 112 may also comprise creating a task description 106 based on a user query (such as a newly submitted user query or the original user query).

Based on the additional information 114 provided by user 102, plan executor 120 may perform tasks such as extracting data. The data extraction may be accomplished by calling an API function that requests data 204. The API call 204 may be submitted to an application 208 that contains data 206 such as data inside data store 125. The data 206 may be returned to plan executor, which may organize the data 206 (such as by executing steps in the plan 112) and provide the structured data to response generator 130, which may generate a response 116 based on the data.

### Example Operations Related to Automatically Generating Responses to User Queries

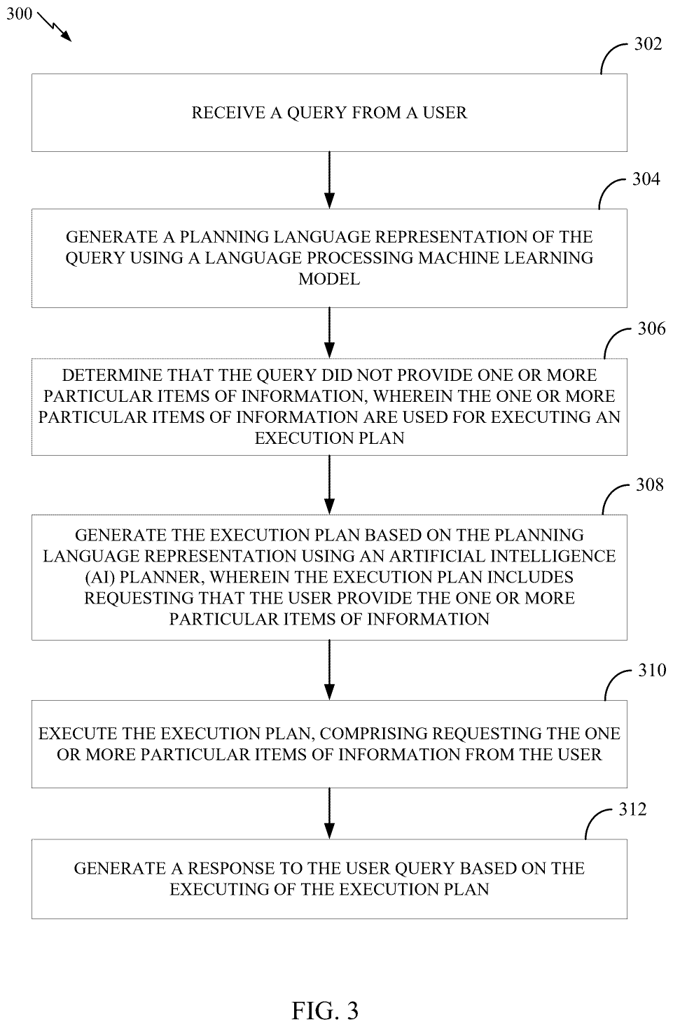

FIG. 3 depicts example operations 300 related to automatically generating responses to user queries. For example, operations 300 may be performed by one or more of the components described in FIG. 1 and FIG. 2.

Operations 300 begin at step 302 with receiving a query from a user.

Operations 300 continue at step 304 with generating a planning language representation of the query using a language processing machine learning model.

Operations 300 continue at step 306 with determining that the query did not provide one or more particular items of information, wherein the one or more particular items of information are used for executing an execution plan. In some embodiments, a request for an additional item of information is made based on the one or more particular items of information.

Operations 300 continue at step 308 with generating the execution plan based on the planning language representation using an artificial intelligence (AI) planner, wherein the execution plan includes requesting that the user provide the one or more particular items of information. According to certain embodiments, a new execution plan is generated based on the one or more particular items of information. Some embodiments provide that the requesting is based on calling a particular API function, wherein the particular API function is configured to request that the user provide the one or more particular items of information. Certain embodiments provide that a determination is made not to execute a subset of the set of steps of a plan based on the one or more particular items of information. Some embodiments provide that an order for executing steps of the set of steps is determined based on the one or more particular items of information. In certain embodiments, additional steps are added to the plan based on the one or more particular items of information.

According to some embodiments, the execution plan comprises a set of steps. Some embodiments provide that a determination is made not to execute a subset of the set of steps based on the one or more particular items of information. In some embodiments, additional steps are added to the plan based on the one or more particular items of information.

Operations 300 continue at step 310 with executing the execution plan, comprising requesting the one or more particular items of information from the user. In certain embodiments, executing the execution plan comprises calling a given API function, wherein the given API function performs an action based on the one or more particular items of information. According to some embodiments, a response is generated based on the performing of the action.

Operations 300 continue at step 312 with generating a response to the user query based on the executing of the execution plan. In some embodiments, the response is generated by a large language model (LLM).

### Additional Example Operations Related to Automatically Generating Responses to User Queries

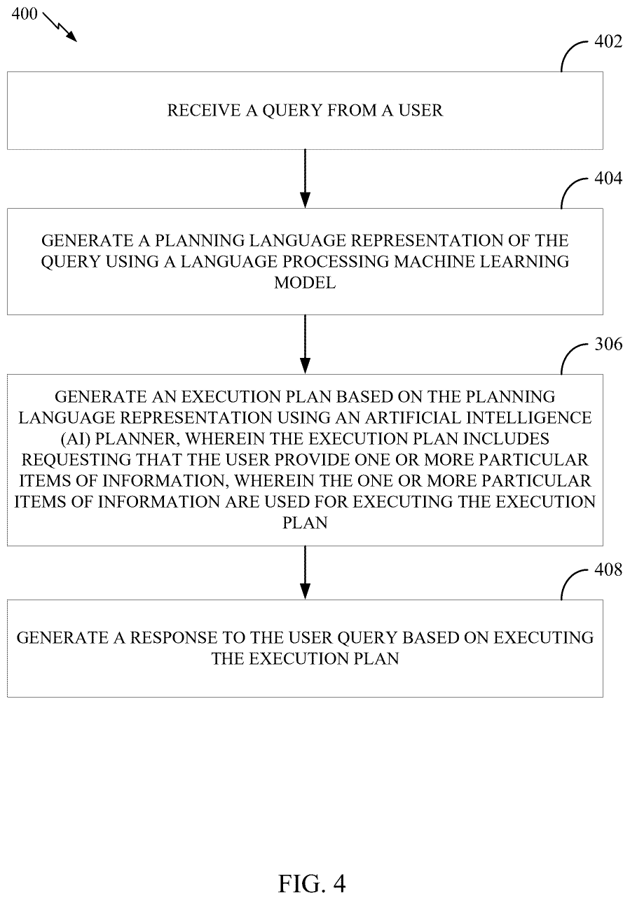

FIG. 4 depicts additional example operations 400 related to automatically generating responses to user queries. For example, operations 400 may be performed by one or more of the components described in FIG. 1 and FIG. 2.

Operations 400 begin at step 402 with receiving a query from a user.

Operations 400 continue at step 404 with generating a planning language representation of the query using a language processing machine learning model.

Operations 400 continue at step 406 with generating an execution plan based on the planning language representation using an artificial intelligence (AI) planner, wherein the execution plan includes requesting that the user provide one or more particular items of information, wherein the one or more particular items of information are used for executing the execution plan.

Operations 400 continue at step 408 with generating a response to the user query based on executing the execution plan.

### Example of a Processing System for Automated Transaction Categorization

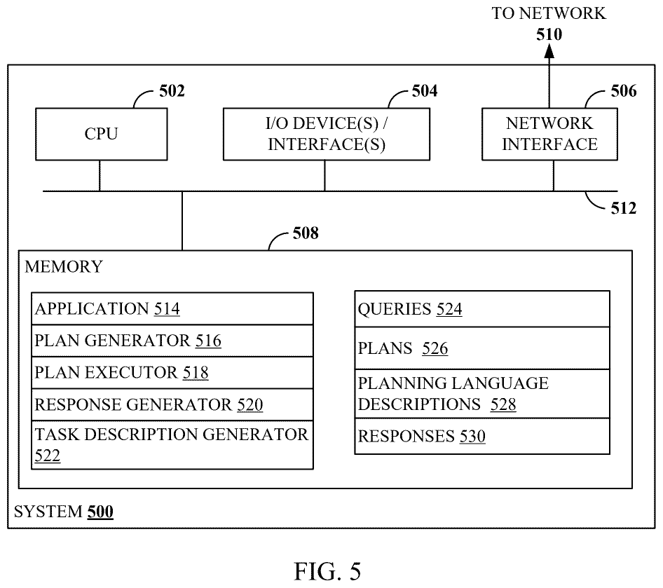

FIG. 5 illustrates an example system 500 with which embodiments of the present disclosure may be implemented. For example, system 500 may be configured to perform operations 300 or 400 of FIG. 3 or FIG. 4 and/or to implement one or more components as in FIG. 1 or FIG. 1.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes application 514, plan generator 516, plan executor 518, response generator 520, and task description generator 522. Application 514 may be representative of application 208 of FIG. 2. In some embodiments, plan generator 516 may be representative of plan generator 110 of FIG. 1 and FIG. 2. Plan executor 518 may be representative of plan executor 120 of FIG. 1 and FIG. 2. Response generator 520 may be representative of response generator 130 of FIG. 1 and FIG. 2. Task description generator 522 may be representative of task description generator 105 of FIG. 1.

Memory 508 further comprises queries 524, which may correspond to user query 104 of FIG. 1. Memory 508 further comprises plans 526 which may correspond to plan 112 of FIG. 1 and FIG. 2. Memory 508 further comprises planning language descriptions 528, which may include task description 106 and domain description 108 of FIG. 1 and FIG. 2. Memory 508 further comprises responses 530, which may correspond to response 116 of FIG. 1 and FIG. 2.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of generating a response to a user query, comprising:
receiving a query from a user;
generating a planning language representation of the query using a language processing machine learning model;
determining that the query did not provide one or more particular items of information, wherein the one or more particular items of information are used for executing an execution plan;
generating the execution plan based on the planning language representation using an artificial intelligence (AI) planner, wherein the execution plan includes requesting that the user provide the one or more particular items of information;
executing the execution plan, comprising requesting the one or more particular items of information from the user; and
generating a response to the user query based on the executing of the execution plan.

2. The method of claim 1, further comprising generating a new execution plan based on receiving the one or more particular items of information.

3. The method of claim 1, wherein executing the execution plan comprises calling a given API function, wherein the given API function performs an action based on the one or more particular items of information.

4. The method of claim 1, wherein the requesting is based on calling a particular API function, wherein the particular API function is configured to request that the user provide the one or more particular items of information.

5. The method of claim 4, wherein the particular API function is configured to present the user with a prompt that is generated based on the one or more particular items of information, wherein the prompt comprises a request to provide the one or more particular items of information.

6. The method of claim 1, wherein the response is generated by a large language model (LLM).

7. The method of claim 1, wherein the execution plan comprises a set of steps, wherein a determination is made not to execute a subset of the set of steps based on the one or more particular items of information.

8. The method of claim 1, wherein the execution plan comprises a set of steps, wherein an order for executing steps of the set of steps is determined based on the one or more particular items of information.

9. The method of claim 1, wherein the execution plan comprises a set of steps, wherein additional steps are added to the plan based on the one or more particular items of information.

10. The method of claim 1, wherein a request for an additional item of information is made based on the one or more particular items of information.

11. A method of generating a response to a user query, comprising:
receiving a query from a user;
generating a planning language representation of the query using a language processing machine learning model;
generating an execution plan based on the planning language representation using an artificial intelligence (AI) planner, wherein the execution plan includes requesting that the user provide one or more particular items of information, wherein the one or more particular items of information are used for executing the execution plan; and
generating a response to the user query based on executing the execution plan.

12. A system for generating a response to a user query, comprising:
one or more processors; and
a memory comprising instructions that, when executed by the one or more processors, cause the system to:
receive a query from a user;
generate a planning language representation of the query using a language processing machine learning model;
determine that the query did not provide one or more particular items of information, wherein the one or more particular items of information are used for executing an execution plan;
generate the execution plan based on the planning language representation using an artificial intelligence (AI) planner, wherein the execution plan includes requesting that the user provide the one or more particular items of information;
execute the execution plan, comprising requesting the particular item of information from the user; and
generate a response to the user query based on the execution of the execution plan.

13. The system of claim 12, wherein the instructions further cause the system to generate a new execution plan based on receiving the one or more particular items of information.

14. The system of claim 12, wherein executing the execution plan comprises calling a given API function, wherein the given API function performs an action based on the one or more particular items of information.

15. The system of claim 12, wherein the requesting is based on calling a particular API function, wherein the particular API function is configured to request that the user provide the one or more particular items of information.

16. The system of claim 15, wherein the particular API function is configured to present the user with a prompt that is generated based on the one or more particular items of information, wherein the prompt comprises a request to provide the one or more particular items of information.

17. The system of claim 12, wherein the response is generated by a large language model (LLM).

18. The system of claim 12, wherein the execution plan comprises a set of steps, wherein a determination is made not to execute a subset of the set of steps based on the one or more particular items of information.

19. The system of claim 12, wherein the execution plan comprises a set of steps, wherein additional steps are added to the plan based on the one or more particular items of information.

20. The system of claim 12, wherein a request for an additional item of information is made based on the one or more particular items of information.
